(19) United States
(12) Patent Application Publication
(10) Pub. No.: US 2022/0122066 A1
(43) Pub. Date: Apr. 21, 2022

(54) SYSTEM AND METHOD FOR REMOTE MANAGEMENT OF DIGITAL ASSETS

(71) Applicant: Xiaonan Du, Beijing (CN)

(72) Inventor: Xiaonan Du, Beijing (CN)

(21) Appl. No.: 17/051,168

(22) PCT Filed: Jan. 6, 2020
(86) PCT No.: PCT/CN2020/070530

§ 371 Date: Oct. 27, 2020

(30) Foreign Application Priority Data
Dec. 13, 2019 (CN) 201911288733.9
Dec. 23, 2019 (CN) 201911324225.1
Dec. 23, 2019 (CN) 201911342713.5
Dec. 23, 2019 (CN) 201911345059.3

(51) Int. Cl. G06Q 20/38; G06Q 20/32; H04L 9/40; H04L 9/14; H04L 9/08

(52) U.S. Cl. CPC G06Q 20/3829; G06Q 20/3276; H04L 9/0819; H04L 9/14; H04L 63/0209

(57) ABSTRACT

A system for remote management of digital assets is disclosed which including a financial management server communicating with an external network, a management server communicating with the financial management server through a first communication channel, a key server communicating with the management server through a second communication channel, a first local encryption machine communicating with the key server through a third communication channel, at least a first remote encryption machine and a second remote encryption machine communicating with the first local encryption machine through a fourth communication channel. The private keys are stored in the different encryption machines and the signatures are also carried out in the different encryption machine, such that even if some encryption machines are hacked, the private key will not be disclosed.

### TECHNICAL FIELD

The present disclosure relates generally to digital assets custody field, and more particularly relates to a system and method for remote management of digital assets.

### BACKGROUND

Digital assets refer to the non-monetary assets owned or controlled by enterprises or individuals in the form of electronic data and held for sale in the daily activities or in the production process, such as the software, firmware, executable instructions, digital certificate (such as the public key certificate), password key, Bitcoin of the computer equipment. These digital assets are usually stored in some management platform of digital assets.

Due to the high value of digital assets, many hackers use various technical means to attack the management platform of digital assets, so as to steal the digital assets. However, the existing management platform of digital assets is vulnerable to the network attacks and has greater security risks and information leakage risks.

### SUMMARY

The object of the present disclosure is to provide a system and method for remote management of digital assets which can protect the key safely and efficiently, so as to ensure the security of digital assets, aiming at the above problem that the existing management platform of digital assets is vulnerable to the network attacks and has greater security risks and information leakage risks.

In a first aspect, a system for remote management of digital assets is provided, which comprising a financial management server communicating with an external network, a management server communicating with the financial management server through a first communication channel, a key server communicating with the management server through a second communication channel, a first local encryption machine communicating with the key server through a third communication channel, at least a first remote encryption machine and a second remote encryption machine communicating with the first local encryption machine through a fourth communication channel;

wherein the financial management server receives a key application and transmits the key application to the key server through the management server, the key server generates a key and transmits the key to the first local encryption machine; wherein the first local encryption machine encrypts the key to generate an encrypted private key and a public key and returns the public key to the key server, generates at least three private keys based on the encrypted private key and stores a first private key internally and transmits a second private key and a third private key to the first remote encryption machine and the second remote encryption machine, respectively; wherein the key server returns the public key to the financial management server along an original path.

Advantageously, the financial management server receives a transaction data to be signed and transmits it to the key server through the management server; the key server encrypts the transaction data to be signed with the public key and transmits encrypted data to the first local encryption machine, wherein the first local encryption machine signs the encrypted data with the first private key and then transmits a primary signature data to the first remote encryption machine and/or the second remote encryption machine; the first remote encryption machine and/or the second remote encryption machine sign the primary signature data with the second private key and/or the third private key again and then returns a secondary signature data to the key server which returns the secondary signature data to the financial management server along the original path.

Advantageously, the third communication channel includes a first acoustic transceiver arranged on the key server and a second acoustic transceiver arranged on the first local encryption machine; wherein the first acoustic transceiver is connected with the key server through a USB interface, and the second acoustic transceiver is connected with the first local encryption machine through a USB interface.

Advantageously, the third communication channel includes a first QR code scanning communication device arranged on the key server and a second QR code scanning communication device arranged on the first local encryption machine, wherein the first QR code scanning communication device is communicated with the key server through a USB interface, and the second QR code scanning communication device is communicated with the first local encryption machine through a USB interface; wherein each QR code scanning communication device comprises a scanning unit and a display unit respectively.

Advantageously, the key server and the first local encryption machine are physically isolated from each other, and the first local encryption machine is connected with the first remote encryption machine and the second remote encryption machine with dedicated lines respectively.

Advantageously, the financial management server receives the transaction data to be signed and transmits it to the key server through the management server; the key server encodes the transaction data to be signed to obtain a QR code and then encrypts obtained QR code with the public key and displays encrypted QR code on its corresponding display unit, the first local encryption machine obtains the encrypted QR code through its corresponding scanning unit, decrypts the encrypted QR code with the first private key to obtain the transaction data and signs the transaction data with the first private key to obtain a primary signature data and transmits the primary signature data to the first remote encryption machine and/or the second remote encryption machine according to the management server instruction; wherein the first remote encryption machine and/or the second remote encryption machine sign the primary signature data with the second private key and/or the third private key again and then returns a secondary signature data to the first local encryption machine; wherein the first local encryption machine encodes the secondary signature data to obtain a second signature QR code and displays the second signature QR code on its corresponding display unit; wherein the key server scans the second signature QR code to obtain the secondary signature data through its corresponding scanning unit, and returns the secondary signature data to the financial management server along the original path.

Advantageously, the scanning unit is a scanner, the display unit is a liquid crystal display screen pasted with an anti-peeping film.

Advantageously, a first firewall is arranged in the first communication channel, the management server is arranged in an internal network; a second firewall is arranged in the second communication channel, and the key server is arranged in an isolated network.

Advantageously, the system for remote management of digital assets further comprises a second local encryption machine arranged between the key server and the first local encryption machine, such that the second local encryption machine is communicating with the key server through the third communication channel and with the first local encryption machine through a fifth communication channel.

Advantageously, the financial management server receives a key application and transmits the key application to the key server through the management server, the key server generates a key and transmits the key to the second local encryption machine which forwards the key to the first local encryption machine; wherein the first local encryption machine encrypts the key to generate an encrypted private key and a public key and returns the public key to the key server, generates at least three private keys based on the encrypted private key and stores a first private key internally and transmits a second private key and a third private key to the first remote encryption machine and the second remote encryption machine, respectively; wherein the key server returns the public key to the financial management server along the original path.

Advantageously, the financial management server receives a transaction data to be signed and transmits it to the key server through the management server; the key server forwards the transaction data to be signed to the second local encryption machine; the second local encryption machine which encrypts the transaction data to be signed with the public key and transmits encrypted data to the first local encryption machine, wherein the first local encryption machine signs the encrypted data with the first private key and then transmits a primary signature data to the first remote encryption machine and/or the second remote encryption machine; the first remote encryption machine and/or the second remote encryption machine sign the primary signature data with the second private key and/or the third private key again and then returns a secondary signature data to the key server which returns the secondary signature data to the financial management server along the original path.

Advantageously, the third communication channel includes a first acoustic transceiver arranged on the key server and a second acoustic transceiver arranged on the second local encryption machine; wherein the first acoustic transceiver is connected with the key server through a USB interface, and the second acoustic transceiver is connected with the second local encryption machine through a USB interface.

Advantageously, the fifth communication channel includes a first QR code scanning communication device arranged on the second local encryption machine and a second QR code scanning communication device arranged on the first local encryption machine, wherein the first QR code scanning communication device is communicated with the second local encryption machine through a USB interface, and the second QR code scanning communication device is communicated with the first local encryption machine through a USB interface; wherein each QR code scanning communication device comprises a scanning unit and a display unit respectively.

Advantageously, the first local encryption machine and the second local encryption machine are arranged in a closed space, while the key server is arranged outside the closed space, the first local encryption machine is connected with the first remote encryption machine and the second remote encryption machine with dedicated lines respectively.

Advantageously, the financial management server receives the transaction data to be signed and transmits it to the key server through the management server; the key server forwards the transaction data to be signed to the second local encryption machine through the first acoustic transceiver, the second local encryption machine receives the transaction data to be signed through the second acoustic transceiver, encodes the transaction data to be signed to obtain a QR code and then encrypts obtained QR code with the public key and displays encrypted QR code on its corresponding display unit, the first local encryption machine obtains the encrypted QR code through its corresponding scanning unit, decrypts the encrypted QR code with the first private key to obtain the transaction data and signs the transaction data with the first private key to obtain a primary signature data and transmits the primary signature data to the first remote encryption machine and/or the second remote encryption machine according to the management server instruction; wherein the first remote encryption machine and/or the second remote encryption machine sign the primary signature data with the second private key and/or the third private key again and then returns a secondary signature data to the first local encryption machine; wherein the first local encryption machine encodes the secondary signature data to obtain a second signature QR code and displays the second signature QR code on its corresponding display unit; wherein the second local encryption machine scans the second signature QR code to obtain the secondary signature data through its corresponding scanning unit, and returns the secondary signature data to the financial management server along the original path.

Advantageously, a wireless signal isolator is installed in the closed space, the scanning unit is a scanner, the display unit is a liquid crystal display screen pasted with an anti-peeping film.

Advantageously, a first firewall is arranged in the first communication channel, the management server is arranged in an internal network; a second firewall is arranged in the second communication channel, and the key server is arranged in an isolated network.

Advantageously, the system for remote management of digital assets further comprises a wallet server and an online encryption machine; wherein the wallet server is communicating with the financial management server through the first communication channel and with the key server through the second communication channel, wherein the wallet server is further communicating with the online encryption machine at the same time;

wherein the wallet server receives a digital asset storage request and stores a first proportion of digital assets into the online encryption machine and a second proportion of digital assets into the first remote encryption machine and/or the second remote encryption machine according to a scheduled rule;

the financial management server receives a digital asset retrieval request and transmits it to the wallet server which retrieves the digital assets from the online encryption machine, the first remote encryption machine and/or the second remote encryption machine according to the scheduled rule and returns the digital assets to the financial management server.

Advantageously, the financial management server receives a key application and transmits the key application to the key server through the management server, the key server generates a key and transmits the key to the first local encryption machine and the online encryption machine; wherein the online encryption machine encrypts the key to generate a first encrypted private key and a first public key, stores the first encrypted private key internally and returns the first public key to the key server and the financial management server; the first local encryption machine encrypts the key to generate a second encrypted private key and a second public key and returns the second public key to the key server, generates at least three private keys based on the encrypted private key and stores a first private key internally and transmits a second private key and a third private key to the first remote encryption machine and the second remote encryption machine, respectively; wherein the key server returns the second public key to the financial management server along an original path.

Advantageously, the wallet server parses out a first transaction data to be signed by the online encryption machine and/or a second transaction data to be signed by the first remote encryption machine and/or the second remote encryption machine based on the digital asset retrieval request and the scheduled rule; the key server encrypts the first transaction data with the first public key and transmits a first encrypted data to the online encryption machine through the wallet server, the online encryption machine signs the first encrypted data with the first encrypted private key, and then returns generated first signature data to the financial management server along the original path; wherein the key server encrypts the second transaction data with the second public key and transmits a second encrypted data to the first local encryption machine through the third communication channel, the first local encryption machine signs the second encrypted data with the first private key and then transmits a primary signature data to the first remote encryption machine and/or the second remote encryption machine; the first remote encryption machine and/or the second remote encryption machine sign the primary signature data with the second private key and/or the third private key again and then returns a secondary signature data to the key server which returns the secondary signature data to the financial management server along the original path.

Advantageously, the system for remote management of digital assets further comprises a wallet server and an online encryption machine; wherein the wallet server is communicating with the financial management server through the first communication channel and with the key server through the second communication channel, wherein the wallet server is further communicating with the online encryption machine at the same time;

wherein the wallet server receives a digital asset storage request and stores a first proportion of digital assets into the online encryption machine and a second proportion of digital assets into the first remote encryption machine and/or the second remote encryption machine according to a scheduled rule;

the financial management server receives a digital asset retrieval request and transmits it to the wallet server which retrieves the digital assets from the online encryption machine, the first remote encryption machine and/or the second remote encryption machine according to the scheduled rule and returns the digital assets to the financial management server.

Advantageously, the financial management server receives a key application and transmits the key application to the key server through the management server, the key server generates a key and transmits the key to the second local encryption machine and the online encryption machine; wherein the online encryption machine encrypts the key to generate a first encrypted private key and a first public key, stores the first encrypted private key internally and returns the first public key to the key server and the financial management server; the second local encryption machine forwards the key to the first local encryption machine which encrypts the key to generate a second encrypted private key and a second public key and returns the second public key to the key server through the second local encryption machine, generates at least three private keys based on the encrypted private key and stores a first private key internally and transmits a second private key and a third private key to the first remote encryption machine and the second remote encryption machine, respectively; wherein the key server returns the second public key to the financial management server along an original path.

Advantageously, the wallet server parses out a first transaction data to be signed by the online encryption machine and/or a second transaction data to be signed by the first remote encryption machine and/or the second remote encryption machine based on the digital asset retrieval request and the scheduled rule; the key server encrypts the first transaction data with the first public key and transmits a first encrypted data to the online encryption machine through the wallet server, the online encryption machine signs the first encrypted data with the first encrypted private key, and then returns generated first signature data to the financial management server along the original path; wherein the key server forward the second transaction data to the second local encryption machine which encrypts the second transaction data with the second public key and transmits a second encrypted data to the first local encryption machine through the fourth communication channel, the first local encryption machine signs the second encrypted data with the first private key and then transmits a primary signature data to the first remote encryption machine and/or the second remote encryption machine; the first remote encryption machine and/or the second remote encryption machine sign the primary signature data with the second private key and/or the third private key again and then returns a secondary signature data to the key server which returns the secondary signature data to the financial management server along the original path.

Advantageously, the wallet server firstly determines whether total digital assets stored in the online encryption machine meets the digital asset retrieval request; if yes, the digital assets are retrieved from the online encryption machine and returned to the financial management server, or lese, first digital assets are retrieved from the online encryption machine and second digital assets are retrieved from the first remote encryption machine and/or the second remote encryption machine and then returned to the financial management server; wherein a sum of the first digital assets and the second digital assets is greater than or equal to the digital asset retrieval request.

Advantageously, when the sum of the first digital assets and the second digital assets is greater than the digital asset retrieval request, the financial management server returns remaining digital assets to the online encryption machine for storage.

In a second aspect, a method for remote management of digital assets is provided, which comprising steps of:

S1. constructing the system for remote management of digital assets discussed above;

S2. completing a key application by using the system for remote management of digital assets;

S3. completing a transaction data signature by using the system for remote management of digital assets.

Advantageously, the method for remote management of digital assets further comprises S4. completing a digital assets storage by using the system for remote management of digital assets.

Advantageously, in step S3, completing a transaction data signature and retrieving the digital assets by using the system for remote management of digital assets.

By implementing the system and method for remote management of digital assets, the private keys are stored in the different encryption machines and the signatures are also carried out in the different encryption machine, such that even if some encryption machines are hacked, the private key will not be disclosed. In additional, the system for remote management of digital assets is isolated through the multi-layer network isolation, the defects of being vulnerable to network attacks, having greater security risks and information leakage risks, can be avoided. Furthermore, the digital assets are stored in the remote encryption machine and the online encryption machine according to different proportions, which is convenient for quick access while having enhanced security. For the digital assets stored in the online encryption machine, customers can quickly access. For the digital assets stored in the remote encryption machine, the private key is stored in the different remote encryption machines and the signatures are also carried out in the different remote encryption machines, such that even if some encryption machines are hacked, the private key will not be disclosed. The security of the digital assets is further guaranteed. Furthermore, the storage ratio and access rules of digital assets in the online and remote encryption machines can be configured flexibly and conveniently.

### BRIEF DESCRIPTION OF THE DRAWINGS

FIG. 1 is a schematic block diagram of a system for remote management of digital assets according to a first preferred embodiment of the present disclosure.

FIG. 2 is a schematic block diagram of a system for remote management of digital assets according to a second preferred embodiment of the present disclosure.

FIG. 3 is a schematic block diagram of a system for remote management of digital assets according to a third preferred embodiment of the present disclosure.

FIG. 4 is a schematic block diagram of a system for remote management of digital assets according to a fourth preferred embodiment of the present disclosure.

FIG. 5 is a schematic block diagram of a third communication channel of the system for remote management of digital assets according to a first preferred embodiment of the present disclosure.

FIG. 6 is a structural diagram of a third communication channel of the system for remote management of digital assets according to a second preferred embodiment of the present disclosure.

FIG. 7 is a structural diagram of a third communication channel and fifth communication channel of the system for remote management of digital assets according to a further preferred embodiment of the present disclosure.

FIG. 8 is a flowchart of a method for remote management of digital assets according to a first preferred embodiment of the present disclosure.

FIG. 9 is a flowchart of a method for remote management of digital assets according to a second preferred embodiment of the present disclosure.

### DETAILED DESCRIPTION OF THE PREFERRED EMBODIMENT

In order to make the purpose, technical scheme and advantages of the present disclosure clearer and more obvious, the present disclosure is further described in detail in combination with the attached drawings and embodiments. It should be understood that the specific embodiments described herein are intended to explain the present disclosure only and are not intended to limit the present disclosure.

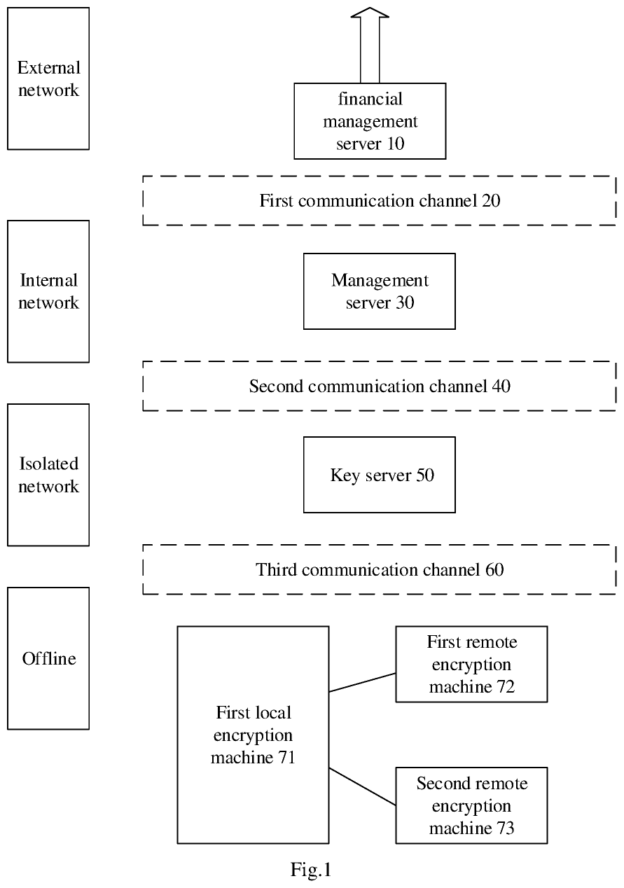

FIG. 1 is a schematic block diagram of a system for remote management of digital assets according to a first preferred embodiment of the present disclosure. As shown in FIG. 1, the system for remote management of digital assets comprises a financial management server 10 communicating with an external network, a management server 30 communicating with the financial management server 10 through a first communication channel 20, a key server 50 communicating with the management server 30 through a second communication channel 40, a first local encryption machine 71 communicating with the key server 50 through a third communication channel 60, and at least a first remote encryption machine 72 and a second remote encryption machine 73 communicating with the first local encryption machine 71 through a fourth communication channel.

In the present disclosure, the key server 50 and the first local encryption machine 71 are physically isolated in the same location. In a preferable embodiment of the present application, the key server 50 and the first local encryption machine 71 are arranged in a same closed space. Of course, they still can be arranged in different closed spaces which are close but separated with each other. The first remote encryption machine 72 and the second remote encryption machine 73, and the first local encryption machine 71 and the key server 50, are located in locations, preferably in different computer rooms in different cities. The first remote encryption machine 72 and the second remote encryption machine 73 can be located in different computer rooms in the same city, but preferably located in different computer rooms in different cities, and cannot communicate with each other, or can communicate with each other just through dedicated lines. Preferably, the first remote encryption machine 72 and the second remote encryption machine 73 can communicate with the first local encryption machine 71 through dedicated lines, but they do not communication with each other and are located in different computer rooms in different cities.

As shown in FIG. 1, the first communication channel 20 and the second communication channel 40 are both network channels. The first communication channel 20 is arranged with a first firewall. The management server 30 is arranged in an internal network. The second communication channel 40 is arranged with a second firewall. The key server 50 is arranged in an isolated network. In this case, the first local encryption machine 71, the first remote encryption machine 72 and the second remote encryption machine 73 all are offline encryption machines. In the present disclosure, “offline” means not connected to any network. The offline encryption machine means that such machine cannot communicate with an external network, and cannot communicate with other devices or equipment in any other way except for the communication mode specified herein.

In the present embodiment, the financial management server 10 receives a key application and transmits the key application to the management serves 30 arranged in the internal network. The management serves 30 transmits the key application to the key server 50 arranged in the isolated network though the second communication channel 40. The key server 50 generates a key and transmits the key to the first local encryption machine 71. The first local encryption machine 71 encrypts the key to generate an encrypted private key and a public key and returns the public key to the key server 50. The key server 50 returns the public key to the financial management server 10 along the original path, which can also be referred as the coming path. Meanwhile, the first local encryption machine 71 generates at least three private keys based on the encrypted private key and stores a first private key internally and transmits a second private key and a third private key to the first remote encryption machine 72 and the second remote encryption machine 73, respectively. In a further preferred embodiment of the present disclosure, four, five or more private keys can be generated. In these embodiments, more remote encryption machines can be included, which can be located in the same or different locations, and each remote encryption machine stores one private key. Of course, the more the number of the remote encryption machines, the hard the hacker attack, while the higher the cost. Therefore, the number of the encryption machines can be arranged according to the actual needs. Based on the teaching of the present disclosure, one skilled in the art can implement different numbers of remote encryption machines.

Since the first communication channel 20 and the second communication channel 40 are respectively provided with firewalls, the security guarantee ability can be enhanced. Furthermore, multiple layers of isolation can be achieved by isolating the external network from the internal network, isolating the internal network from the isolated network, and physically isolating the isolated network from the offline encryption machine. The security guarantee ability can be further enhanced as the first local encryption machine 71, first remote encryption machine 72 and the second remote encryption machine 73 are all offline encryption machines and are connected through dedicated lines. Moreover, the private keys are stored in multiple offline encryption machines, such that even if some encryption machines are hacked, the private key will not be disclosed.

In the present embodiment, when there is transaction data to be signed, the financial management server 10 similarly receives the transaction data to be signed through the external network, and then transmits it to the management server 30 in the internal network through the first communication channel 20. The management server 30 transmits the transaction data to be signed to the key server 50 in the isolated network through the second communication channel 40. The key server 50 encrypts the transaction data to be signed with the public key to obtain encrypted data and then transmits the encrypted data to the first local encryption machine 71. The first local encryption machine 71 signs the encrypted data with the first private key stored by itself to obtain a primary signature data, and then transmits the primary signature data to the first remote encryption machine 72 and/or the second remote encryption machine 73. In a preferred embodiment of the present disclosure, at least one or both of the first remote encryption machine 72 and the second remote encryption machine 73 can be selected through the rules or programs built-in the management server 30. A second signature, even a third signature in a scheduled order can be selected accordingly. For example, in a preferred embodiment of the present disclosure, the first remote encryption machine 72 is selected for signature. The first remote encryption machine 72 signs the primary signature data with the second private key again and then returns a secondary signature data to the key server 50 which returns the secondary signature data to the financial management server 10 along the original path.

In a preferred embodiment of the present disclosure, only two of the first private key, the second private key and the third private key are required to complete the signature. In other preferred embodiments of the present disclosure, the first local encryption machine 71, the first remote encryption machine 72 and the second remote encryption machine 73 can be configured to sign in the order of the first private key to the third private key. Furthermore, more remote encryption machines can be configured, and the number and order of signatures of the remote encryption machines can be further arranged. The system security is further ensured by using the double signature authentication method of local and remote encryption machines. The signature is also carried out in different encryption machines, so even if some encrypting machines are hacked, the private key will not be disclosed.

In a preferred embodiment of the present disclosure, the first remote encryption machine 72 and/or the second remote encryption machine 73 can respectively communicate with the key server 50 through a dedicated line, so the first remote encryption machine 72 and/or the second remote encryption machine 73 can directly return the secondary signature data to the key server 50. In another preferred embodiment of the disclosure, the first remote encryption machine 72 and/or the second remote encryption machine 73 cannot communicate with the key server 50 through the dedicated line, but can only communicate with the local encryption machine 71 through the dedicated line. At this time, the secondary signature data needs to be returned to the local encryption machine 71 firstly and then to the key server 50. In practical application, this method is more preferred because it is safer and more cost-effective.

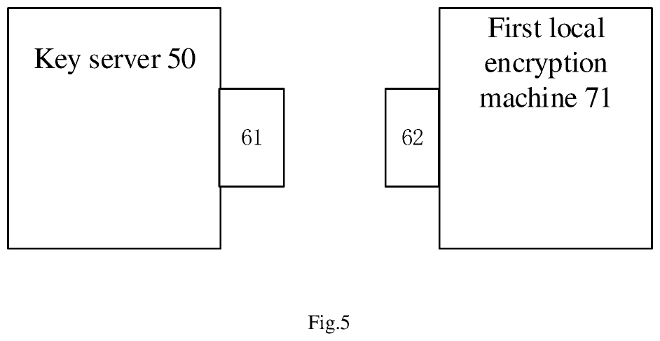

In a preferable embodiment of the present disclosure, as shown in FIG. 5, the third communication channel 60 includes a first acoustic transceiver 61 arranged on the key server 50 and a second acoustic transceiver 62 arranged on the first local encryption machine 71. The first acoustic transceiver 61 is connected with the key server 50 through a USB interface 66, and the second acoustic transceiver 62 is connected with the first local encryption machine 71 through a USB interface 66.

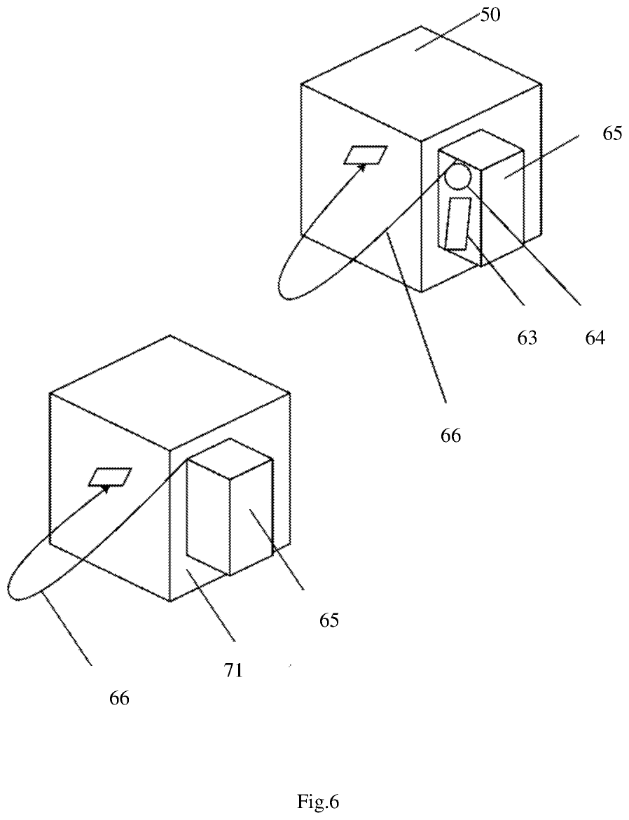

In a preferable embodiment of the present disclosure, as shown in FIG. 6, the third communication channel 60 comprises a first QR code scanning communication device arranged on the key server 50 and a second QR code scanning communication device arranged on the first local encryption machine 71. As shown in FIG. 6, each QR code scanning communication device comprises a scanning unit 64 and a display unit 63 respectively. The scanning unit 64 and display unit 63 are mounted on the key server 50 and the first local encryption machine 71 through a mounting base 65, respectively, and communicated with the key server 50 and the first local encryption machine 71 through the USB interface 66, respectively. In the present embodiment, the key server 50 and the first local encryption machine 71 are arranged in a closed space.

Further referring FIG. 6, the scanning unit 64 and the display unit 63 are respectively located on the same side of the key server 50 and the first local encryption machine 71, so that the scanning unit 64 of the key server 50 is directly facing the display unit 63 of the first local encryption machine 71, and the display unit 63 of the key server 50 is directly facing the scanning unit 64 of the first local encryption machine 71.

In this embodiment, the financial management server 10 receives the transaction data to be signed and transmits the transaction data to be signed to the key server 50 through the management server 30. The key server 50 encodes the transaction data to be signed to obtain a QR code and encrypts the obtained QR code with the public key, and displays the encrypted QR code on its corresponding display unit 63. The first local encryption machine 71 scans and obtains the encrypted QR code through its corresponding scanning unit 64, and then decrypts the encrypted QR code with the local first private key to obtain the transaction data. Then the first local encryption machine 71 signs the transaction data with the local first private key to obtain a primary signature data and transmits the primary signature data to the first remote encryption machine 72 and/or the second remote encryption machine 73 according to the management server instruction of the management server 30. The first remote encryption machine 72 or the second remote encryption machine 73 sign the primary signature data with the second private key and/or the third private key again and then returns a secondary signature data to the first local encryption machine 71. The first local encryption machine 71 encodes the secondary signature data to obtain the second signature QR code and displays the second signature QR code with its corresponding display unit 63. The key server 50 scans and obtains the second signature QR code with its corresponding scanning unit 64, and then obtains the secondary signature data. After that the key server 50 returns the secondary signature data to the financial management server 10 through the original path.

In a preferred embodiment of the present disclosure, the obtained transaction data can be encoded into a QR for display by the display unit using any known encoding method. Furthermore, any encryption method can be used to encrypt the obtained QR code. For example, the common DES and RSA hybrid encryption algorithm can be used. Preferably, the display of the encrypted QR code updates every scheduled time interval, for example. Preferably, the scanning unit 64 can scan and obtain the signature QR code in the manner of regular polling. Of course, in another preferred embodiment of the present disclosure, the scanning unit can also keep scanning all the time so as to obtain the signature QR code at the first time. Preferably, the scanning unit is a scanner, the display unit is a liquid crystal display screen pasted with an anti-peeping film. In this embodiment, the key server and the local encryption machine can only communicate through QR code scanning, the local encryption machine and the remote encryption machine can only communicate through the dedicated line, and the remote encryption machines cannot communicate with each other, so the encryption process is complex and the security degree is high.

By implementing the system for remote management of digital assets, the private keys are stored in the different encryption machines and the signatures are also carried out in the different encryption machine, such that even if some encryption machines are hacked, the private key will not be disclosed. In additional, the system for remote management of digital assets is isolated through the multi-layer network isolation, the defects of being vulnerable to network attacks, having greater security risks and information leakage risks, can be avoided. Furthermore, the multiple-signature transaction further enhances the transaction security.

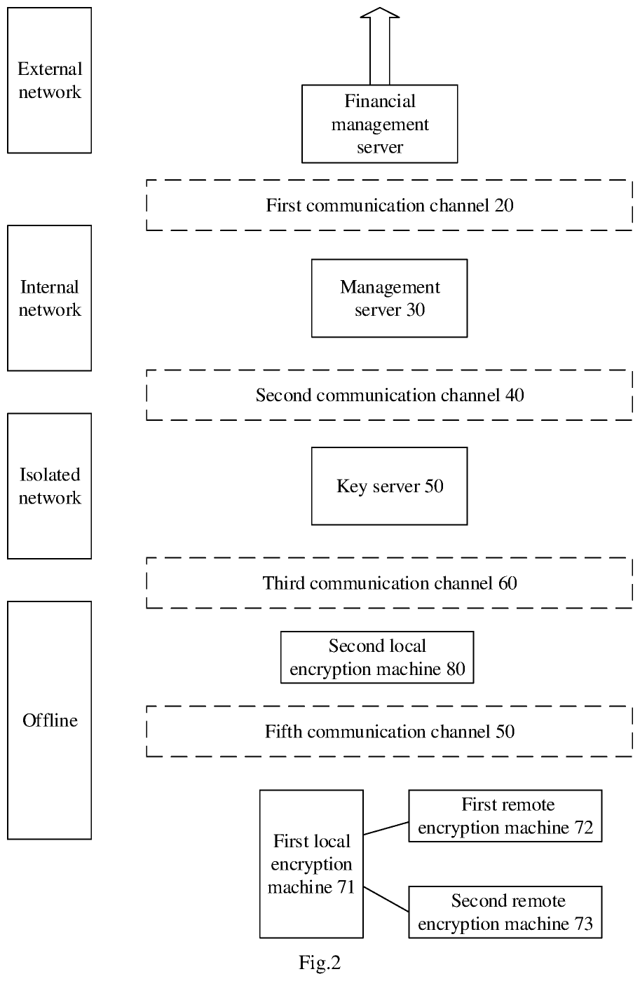

FIG. 2 is a schematic block diagram of a system for remote management of digital assets according to a second preferred embodiment of the present disclosure. As shown in FIG. 2, the system for remote management of digital assets comprises a financial management server 10 communicating with an external network, a management server 30 communicating with the financial management server 10 through a first communication channel 20, a key server 50 communicating with the management server 30 through a second communication channel 40, a second local encryption machine 80 communicating with the key server 50 through a third communication channel 60, and a first local encryption machine 71 communicating with the second local encryption machine 80 through a fifth communication channel 90, and at least a first remote encryption machine 72 and a second remote encryption machine 73 communicating with the first local encryption machine 71 through a fourth communication channel.

In the present embodiment, the financial management server 10, the first communication channel 20, the management server 30, the second communication channel 40, the key server 50, the third communication channel 60, the first local encryption machine 71, the first remote encryption machine 72 and the second remote encryption machine 73 can all be constructed similarly according to the structures of the embodiments shown in FIG. 1. Furthermore, the fifth communication channel 90 and the second local encryption machine 80 can be constructed with reference to the third communication channel 60 and the first local encryption machine 71 shown in FIG. 1. Their principles are similar to the embodiment shown in FIG. 1.

In the present disclosure, the first local encryption machine 71 and the second local encryption machine 80 are located at the same location. In a preferred embodiment of the present disclosure, they are located in the same closed space, and located in the same location as the key server 50, and preferably can communicated with the key server 50 by acoustic waves. The closed space is preferably made of opaque but not sound insulation materials to facilitate sound wave transmission. The first remote encryption machine 72 and the second remote encryption machine 73, and the first local encryption machine 71 and the second local encryption machine 72, are located in locations, preferably in different cities or computer rooms.

In the present embodiment, the financial management server 10 receives a key application and transmits the key application to the management server 30 in the internal network through the first communication channel 20. The management server 30 transmits the key application to the key server 50 located in the isolated network through the second communication channel 40. The key server 50 generates a key and transmits the key to the second local encryption machine 80 which forwards the key to the first local encryption machine 71 through the fifth communication channel 90. The first local encryption machine 71 encrypts the key to generate an encrypted private key and a public key and returns the public key to the financial management server 10 along the original path. The first local encryption machine 71 generates at least three private keys based on the encrypted private key and stores a first private key internally and transmits a second private key and a third private key to the first remote encryption machine 72 and the second remote encryption machine 73, respectively through the dedicated lines.

In the present embodiment, when there is transaction data to be signed, the financial management server 10 similarly receives the transaction data to be signed through the external network. Then, the transaction data to be signed is transmitted to the management server 30 in the internal network through the first communication channel 20. The management server 30 transmits the transaction data to be signed to the key server 50 in the isolated network through the second communication channel 40. The key server 50 forwards the transaction data to be signed to the second local encryption machine 80. The second local encryption machine 80 encrypts the transaction data to be signed with the public key and transmits encrypted data to the first local encryption machine 71. The first local encryption machine 71 signs the encrypted data with the first private key and then transmits a primary signature data to at least one remote encryption machine of the first remote encryption machine 72 and the second remote encryption machine 72. The at least one remote encryption machine signs the primary signature data and then returns a secondary signature data to the first local encryption machine 71 which returns the secondary signature data to the financial management server 10 along the original path.

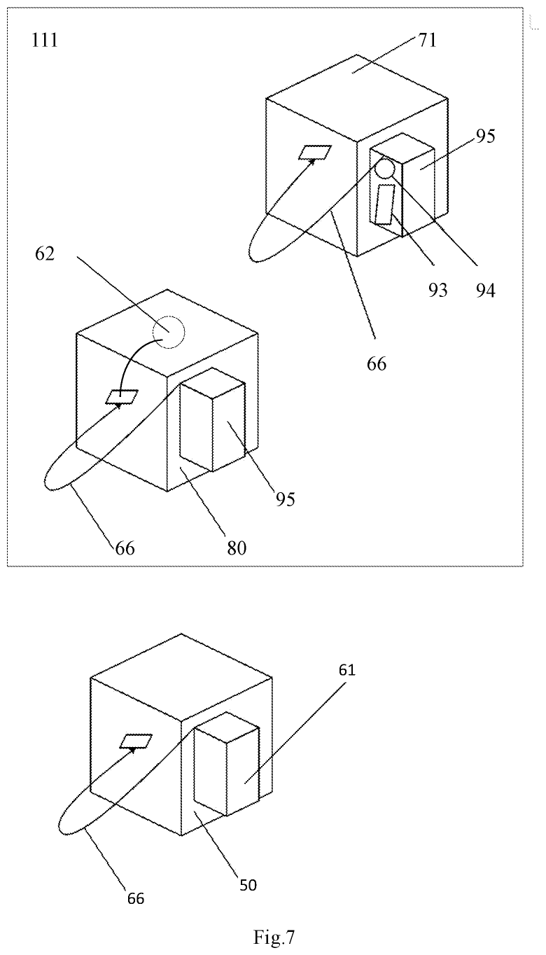

In a preferred embodiment of the disclosure, the third communication channel 60 and the fifth communication channel 90 may adopt special arrangements. FIG. 7 is a structural diagram of a third communication channel and fifth communication channel of the system for remote management of digital assets according to a further preferred embodiment of the present disclosure. As shown in FIG. 7, the third communication channel 60 includes a first acoustic transceiver 61 arranged on the key server 50 and a second acoustic transceiver 62 arranged on the second local encryption machine 80. The first acoustic transceiver 61 is connected with the key server 50 through a USB interface 66, and the second acoustic transceiver 62 is connected with the second local encryption machine 80 through a USB interface 66. The fifth communication channel 90 comprises a first QR code scanning communication device arranged on the second local encryption machine 80 and a second QR code scanning communication device arranged on the first local encryption machine 71. The first QR code scanning communication device is connected with the second local encryption machine 80 through a USB interface 66. The second QR code scanning communication device is connected with the first local encryption machine 71 through a USB interface 66. Each QR code scanning communication device comprises a scanning unit 94 and a display unit 93 respectively. The scanning unit 94 and display unit 93 are mounted on the second local encryption machine 80 and the first local encryption machine 71 through a mounting base 95, respectively, and communicated with the second local encryption machine 80 and the first local encryption machine 71 through the USB interface 66, respectively. In the present embodiment, the second local encryption machine 80 and the first local encryption machine 71 are arranged in a closed space 111, while the key server 50 is arranged outside the closed space 111. The first remote encryption machine 72 and the second remote encryption machine 73 can communicate with the first local encryption machine 71 through dedicated lines. The closed space is preferably made of opaque but not sound insulation materials to facilitate sound wave transmission.

In a preferred embodiment of the disclosure, the financial management server 10 similarly receives the transaction data to be signed and transmits it to the key server 50. The key server 50 forwards the transaction data to be signed to the second acoustic transceiver 62 corresponding to the second local encryption machine 80 through the first acoustic transceiver 61. Similarly as taught before, the second local encryption machine 80 encodes the transaction data to be signed to obtain the QR code, and encrypts the QR code with the public key and displays encrypted QR code on its corresponding display unit 63. The first local encryption machine 71 scans the encrypted QR code with its corresponding scanning unit 64, decrypts the encrypted QR code with the first private key to obtain the transaction data and signs the transaction data with the first private key to obtain a primary signature data and transmits the primary signature data to the first remote encryption machine 72 and/or the second remote encryption machine 73 according to the management server instruction of the management server 30. The first remote encryption machine 72 and/or the second remote encryption machine 73 sign the primary signature data with the second private key and/or the third private key again and then return a secondary signature data to the first local encryption machine 71. The first local encryption machine 71 encodes the secondary signature data to obtain a second signature QR code and displays the second signature QR code on its corresponding display unit 93. The second local encryption machine 80 scans the second signature QR code to obtain the secondary signature data through its corresponding scanning unit 94, and returns the secondary signature data to the financial management server 10 along the original path.

By implementing the system for remote management of digital assets, the private keys are stored in the different encryption machines and the signatures are also carried out in the different encryption machine, such that even if some encryption machines are hacked, the private key will not be disclosed. In additional, the system for remote management of digital assets is isolated through the multi-layer network isolation, the defects of being vulnerable to network attacks, having greater security risks and information leakage risks, can be avoided. In this embodiment, the key server and the first local encryption machine can only communicate through acoustic waves, while the first local encryption machine and the second local encryption machine can only communicate through QR code scanning, so the encryption process is complex and the security degree is high. Furthermore, through the multi-layer firewall isolation, the security risks can be further avoided. Furthermore, the multiple-signature transaction further enhances the transaction security.

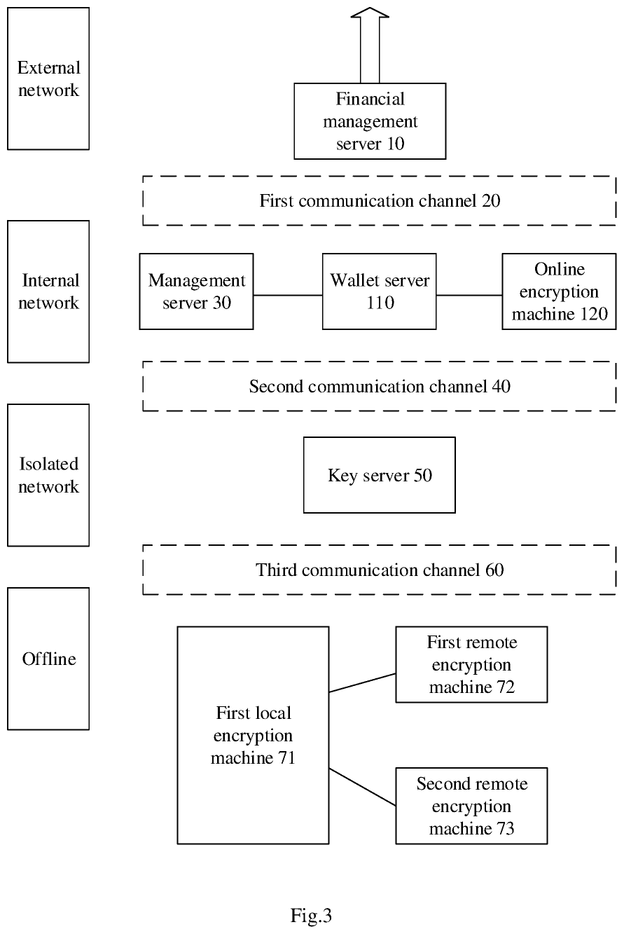

FIG. 3 is a schematic block diagram of a system for remote management of digital assets according to a third preferred embodiment of the present disclosure. As shown in FIG. 3, the system for remote management of digital assets comprises a financial management server 10 communicating with an external network, a management server 30 communicating with the financial management server 10 through a first communication channel 20, a key server 50 communicating with the management server 30 through a second communication channel 40, a first local encryption machine 71 communicating with the key server 50 through a third communication channel 60, and at least a first remote encryption machine 72 and a second remote encryption machine 73 communicating with the first local encryption machine 71 through a fourth communication channel.

In the present embodiment, the system for remote management of digital assets further comprises a wallet server 110 and an online encryption machine 120; wherein the wallet server 110 is communicating with the financial management server 120 through the first communication channel 20 and with the key server 50 through the second communication channel 40. The wallet server 110 is further communicating with the online encryption machine 120 at the same time.

The other functions except the specific function mentioned in the present embodiment of, the financial management server 10, the first communication channel 20, the management server 30, the second communication channel 40, the key server 50, the third communication channel 60, the first local encryption machine 71, the first remote encryption machine 72 and the second remote encryption machine 73 can all be constructed similarly according to the structures of the embodiments shown in FIG. 1. In the present embodiment, the wallet server 110 and online encryption machine 120 can be constructed as following embodiments. Based on the teaching of the present embodiment and the common technical knowledge, one skilled in the art can construct such devices. In the present disclosure, the online encrypting machine 120 refers to that the encryption machine can be connected with the external network through the wallet server 120 and the financial management server 10.

In the present embodiment, during the key application process, the financial management server 10 receives a key application and transmits the key application to the management serves 30 arranged in the internal network. The management serves 30 transmits the key application to the key server 50 arranged in the isolated network though the second communication channel 40. The key server 50 generates a key and transmits the key to the first local encryption machine 71 and the wallet server 110 which further transmits the key to the online encryption machine 120. The online encryption machine 120 encrypts the key to generate a first encrypted private key and a first public key, stores the first encrypted private key internally and returns the first public key to the wallet server 110 which further transmits the public key to the key server 50 and the financial management server 10 through the second communication channel 40 and the first communication channel 20. The first local encryption machine 71 encrypts the key to generate a second encrypted private key and a second public key and returns the second public key to the key server 50, generates at least three private keys based on the second encrypted private key and stores a first private key internally and transmits a second private key and a third private key to the first remote encryption machine 72 and the second remote encryption machine 73, respectively. The key server 50 returns the second public key to the financial management server 10 along the second communication channel 40 and the management server 30. Of course, the key server 50 can also return the second public key to the financial management server 10 along the second communication channel 40 and the wallet server 110. In a further preferred embodiment of the present disclosure, four, five or more private keys can be generated. In these embodiments, more remote encryption machines can be included, which can be located in the same or locations, and each remote encryption machine stores one private key. Since the first communication channel 20 and the second communication channel 40 are respectively provided with firewalls, the security guarantee ability can be enhanced. Furthermore, multiple layers of isolation can be achieved by isolating the external network from the internal network, isolating the internal network from the isolated network, and physically isolating the isolated network from the offline encryption machine. The security guarantee ability can be further enhanced as the first local encryption machine 71, the first remote encryption machine 72 and the second remote encryption machine 73 are all offline encryption machines connected through dedicated lines. Moreover, the private keys are stored in multiple offline encryption machines, such that even if some encryption machines are hacked, the private key will not be disclosed.

When there are digital assets to be stored in, the financial management server 10 receives a digital asset storage request and transmits it to the wallet server 110 which stores a first proportion of digital assets into the online encryption machine 120 and a second proportion of digital assets into at least one of the first remote encryption machine 72 and the second remote encryption machine 73 according to a scheduled rule. Of course, the wallet server 110 still can store a first proportion of digital assets into the online encryption machine 120, a second proportion of digital assets into the first remote encryption machine 72 and a third proportion of digital assets into the second remote encryption machine 73 according to a scheduled rule. When there are multiple remote encryption machines, other configuration can be arranged.

In a preferred embodiment of the present disclosure, a plurality of digital assets from various clients can be received through the financial management server 10. When a certain amount is accumulated, the financial management server 10 generates a digital asset storage request. In another preferred embodiment of the present disclosure, the financial management server 10 may also receive digital asset storage requests from various clients. Usually, a small proportion of digital assets (e.g. 5-10%) will be stored in the online encryption machine to cope with the account circulation, while a large proportion of digital assets (90-95%) will be stored in the remote encryption machine to ensure the account security. The storage manner of the digital assets in the remote encryption machine can be configured according to actual requirements. For example, all digital assets can be written into the same bitcoin wallet address, and then multiple backup bitcoin wallet addresses can be arranged for subsequent asset retrieval operation. Or all digital assets can be written in equally or unequally amounts according to certain proportion rules to different bitcoin wallet addresses to facilitate subsequent asset retrieval operations. Each bitcoin wallet address is invalid after the digital assets are retrieved by the signature.

When the digital assets are to be retrieved, the financial management server 10 receives a digital asset retrieval request from one client or digital asset retrieval requests from multiple clients, and then transmits such request or requests to the wallet server 110 which retrieves the digital asset from the online encryption machine 120, the first remote encryption machine 72 and/or the second remote encryption machine 73 according to the scheduled rule and returns the digital assets to the financial management server 10 which then transmits such digital assets to the clients through the Blockchain. For example, if the wallet server 110 finds that the total amount of the digital assets required to be retrieved by the digital asset retrieval request is lower than the total amount of digital assets stored in the online encryption machine 120, and the remaining digital assets after the retrieval in the online encryption machine 120 will not be lower than the minimum storage amount specified by the online encryption machine 120, the digital assets can be directly retrieved from the online encryption machine 120. If the wallet server 110 finds that the total amount of the digital assets required to be retrieved by the digital asset retrieval request is lower than the total amount of digital assets stored in the online encryption machine 120, but the remaining digital assets after the retrieval in the online encryption machine 120 will be lower than the minimum storage amount specified by the online encryption machine 120, the digital assets can be directly retrieved from the online encryption machine 120 and a specific amount of digital assets would be retrieved from the first remote encryption machine 72 and the second remote encryption machine 73 then or after a specific time period and stored into the online encryption machine 120. Furthermore, if the wallet server 110 finds that the total amount of the digital assets required to be retrieved by the digital asset retrieval request is higher than the total amount of digital assets stored in the online encryption machine 120, the first digital assets are retrieved from the online encryption machine 120 and the second digital assets are retrieved from the first remote encryption machine 72 and/or the second remote encryption machine 73 according to the scheduled rule (such as a certain proportion or requirement). When the sum of the first digital assets and the second digital assets is greater than the digital asset retrieval request, the financial management server 10 returns the remaining digital assets to the online encryption machine 120 for storage. Of course, in another preferable embodiment of the present disclosure, if the wallet server 110 finds that the total amount of the digital assets required to be retrieved by the digital asset retrieval request is relatively large, and the digital assets stored in the online encryption machine 120 is lower than or equal to the minimum storage amount specified by the online encryption machine 120, the digital assets can be directly retrieved from the first remote encryption machine 72 or the second remote encryption machine 73, or both of the first remote encryption machine 72 and the second remote encryption machine 73. Of course, based on the teaching of the present disclosure, one skilled in the art can also configure other rules and requirements. In a further preferred embodiment of the present disclosure, a certain proportion of digital assets are stored in each of the first remote encryption machine 72 and the second remote encryption machine 73 respectively. At this time, the wallet server 110 can be configured to retrieve a certain proportion of digital assets from the first remote encryption machine 72 each time, and a further certain proportion of digital assets from the second remote encryption machine 73.

In a preferred embodiment of the present disclosure, when there are digital assets to be retrieved, the wallet server 80 parses out a first transaction data to be signed by the online encryption machine 120 and/or a second transaction data to be signed by the remote encryption machines 72, 73 based on the digital asset retrieval request and/or the scheduled rule. As mentioned above, when the digital assets only need to be retrieved from the online encryption machine 120, just the first transaction data is parsed out, and when the digital assets only need to be retrieved from the remote encryption machines 72, 73, just the second transaction data is parsed out. In a further embodiment of the present application, when the digital assets are to be retrieved from both of the remote encryption machines 72, 73, a third transaction data can be parsed out. When the digital assets are to be retrieved from the three, the first, the second and the third transaction data can be parsed out.

When the digital assets need to be retrieved from both of the online encryption machine 120 and the first remote encryption machine 72 and/or the second remote encryption machine 73, both of the first and second transaction data are parsed out.

When the first transaction data is parsed out, the key server 50 encrypts the first transaction data with the first public key, and then transmits the first encrypted data to the online encryption machine 120 through the wallet server 110, and the online encryption machine 120 signs the first encrypted data with the first encrypted private key, and then returns the generated first signature data to the wallet server 11 which further returns the first signature data to the financial management server 10 along the original path. When the second transaction data is parsed out, the key server 50 encrypts the second transaction data with the second public key, transmits the second encrypted data to the first local encryption machine 71 through the third communication channel 60. The first local encryption machine 71 signs the second encrypted data with the first private key, and then transmits the primary signature data to the remote encryption machine, such as the first remote encryption machine 72. The first remote encryption machine 72 signs the primary signature data with the second private key again and then returns a secondary signature data to the first local encryption machine 71. Then the first local encryption machine 71 returns the secondary signature data to key server 50 which returns the secondary signature data to the financial management server 10 along the original path.

When a second transaction data and a third transaction data are both parsed out, the key server 50 encrypts the second transaction data and third transaction data to obtain the second encrypted data and the third encrypted data, then transmits the second encrypted data and the third encrypted data to the first local encryption machine 71. The first local encryption machine 71 signs the second encrypted data and the third encrypted data with the first private key, and then transmits the two primary signature data to the first remote encryption machine 72 and the third remote encryption machine 73, respectively. The first remote encryption machine 72 and the third remote encryption machine 73 signs each primary signature data respectively, and then return each secondary signature data to the first local encryption machine 71 which returns both of the secondary signature data to the key server 50. Then the key server 50 returns both of the secondary signature data to the financial management server 10 along the original path. When the first and second transaction data are parsed out at the same time, or the first and third transaction data are parsed out, as well as the first to third transaction data are parsed out, implementations can be carried out with reference to the above description.

By implementing the system for remote management of digital assets, the digital assets are stored in the remote encryption machine and the online encryption machine according to different proportions, which is convenient for quick access while having enhanced security. For the digital assets stored in the online encryption machine, customers can quickly access. For the digital assets stored in the remote encryption machine, the private key is stored in the different remote encryption machines and the signatures are also carried out in the different remote encryption machines, such that even if some encryption machines are hacked, the private key will not be disclosed. The security of the digital assets is further guaranteed. In additional, the system for remote management of digital assets is isolated through the multi-layer network isolation, the defects of being vulnerable to network attacks, having greater security risks and information leakage risks, can be avoided. Furthermore, the key server and the first local encryption machine can only communicate through acoustic waves, while the local encryption machine and the remote encryption machine can only communicate through dedicated lines, the encryption process is complex and the safety degree is high. Furthermore, the storage ratio and access rules of digital assets in the online and remote encryption machines can be configured flexibly and conveniently.

In a preferred embodiment of the present disclosure, the third communication channel 60 may also adopt the embodiments shown in FIG. 5 or FIG. 6. For example, when the embodiment shown in FIG. 6 is adopted, the key server 50 encodes the second transaction data after receiving the second transaction data to obtain QR code and encrypts the obtained QR code with the second public key, and then displays the encrypted QR code on its corresponding display unit 63. The offline encryption machine 70 scans and obtains the encrypted QR code through its corresponding scanning unit 64, and then decrypts the encrypted QR code with the first private key to obtain the second transaction data, signs the second transaction data with the first private key to obtain the primary signature data, and then transmits the primary signature data the remote encryption machine (i.e., the first remote encryption machine or the second remote encryption machine). After the remote encryption machine signs again, the secondary signature data is returned to the first local encryption machine 71 through a dedicated line. The first local encryption machine 71 encodes the secondary signature data to obtain a signature QR code, and then displays the signature QR code on its corresponding display unit 63. The key server 50 scans the signature QR code with its corresponding scanning unit 64 to obtain the secondary signature data, and returns the secondary signature data to the financial management server 10 along the original path. Similarly, in the present embodiment, during the key application process, the communication between the key server 50 and the first local encryption machine 71 is the same, which will not be repeated here. Similarly, if there is any third transaction data, similar process would be carried out.

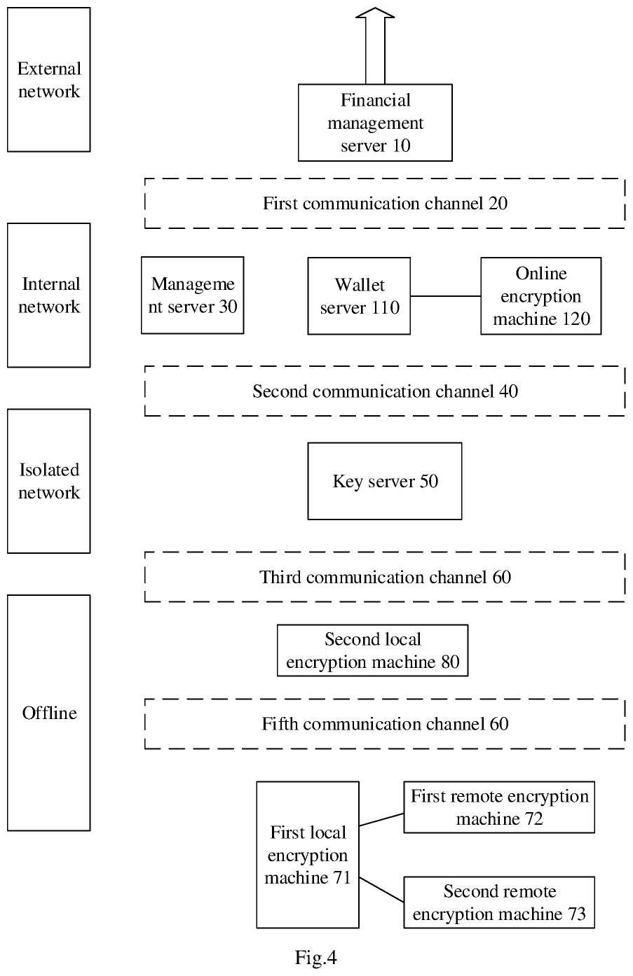

FIG. 4 is a schematic block diagram of a system for remote management of digital assets according to a fourth preferred embodiment of the present disclosure. As shown in FIG. 4, the system for remote management of digital assets comprises a financial management server 10 communicating with an external network, a management server 30 communicating with the financial management server 10 through a first communication channel 20, a key server 50 communicating with the management server 30 through a second communication channel 40, a second local encryption machine 80 communicating with the key server 50 through a third communication channel 60, and a first local encryption machine 71 communicating with the second local encryption machine 80 through a fifth communication channel 90, and at least a first remote encryption machine 72 and a second remote encryption machine 73 communicating with the first local encryption machine 71 through a fourth communication channel. In the present embodiment, the system for remote management of digital assets further comprises a wallet server 110 and an online encryption machine 120. The wallet server 110 is communicating with the financial management server 120 through the first communication channel 20 and with the key server 50 through the second communication channel 40. The wallet server 110 is further communicating with the online encryption machine 120 at the same time.

The other functions except the specific function mentioned in the present embodiment of, the financial management server 10, the first communication channel 20, the management server 30, the second communication channel 40, the key server 50, the third communication channel 60, the first local encryption machine 71, the first remote encryption machine 72 and the second remote encryption machine 73 can all be constructed similarly according to the structures of the embodiments shown in FIG. 2. In the present embodiment, the wallet server 110 and online encryption machine 120 can be constructed according to the structures of the embodiments shown in FIG. 3 Based on the teaching of the present embodiment and the common technical knowledge, one skilled in the art can construct such devices.

In the present embodiment, during the key application process, the financial management server 10 receives a key application and transmits the key application to the key server 50 through the management server 30 as taught before. The key server 50 generates a key and transmits the key to the second local encryption machine 80 and the online encryption machine 120. The online encryption machine 120 encrypts the key to generate a first encrypted private key and a first public key, stores the first encrypted private key internally and returns the first public key to the key server 50 and the financial management server 10. The second local encryption machine 80 forwards the key to the first local encryption machine 71 which encrypts the key to generate a second encrypted private key and a second public key and returns the second public key to the key server 50 through the second local encryption machine 80, generates at least three private keys based on the encrypted private key and stores a first private key internally and transmits a second private key and a third private key to the first remote encryption machine 72 and the second remote encryption machine 73, respectively. The key server 50 returns the second public key to the financial management server 10 along an original path.

When there are digital assets to be retrieved out, the wallet server 10 parses out a first transaction data to be signed by the online encryption machine 120 and/or a second transaction data to be signed by the first remote encryption machine 72 and/or the second remote encryption machine 73 based on the digital asset retrieval request and the scheduled rule. The key server 50 encrypts the first transaction data with the first public key and transmits a first encrypted data to the online encryption machine 120 through the wallet server 110. The online encryption machine 120 signs the first encrypted data with the first encrypted private key, and then returns generated first signature data to the wallet server 110 which return the first signature data to the financial management server 10 along the original path. The key server 50 forwards the second transaction data to the second local encryption machine 80 through the third communication channel 60. The second local encryption machine 80 encrypts the second transaction data with the second public key and transmits the second encrypted data to the first local encryption machine 71. The first local encryption machine 71 signs the second encrypted data with the first private key and then transmits a primary signature data to the first remote encryption machine 72 and/or the second remote encryption machine 73. The first remote encryption machine 72 and/or the second remote encryption machine 73 sign the primary signature data with the second private key and/or the third private key again and then returns a secondary signature data to the key server 50 which returns the secondary signature data to the financial management server 10 along the original path.

In the system for remote management of digital assets, the wallet server 110 firstly determines whether total digital assets stored in the online encryption machine 120 meet the digital asset retrieval request. If yes, the digital assets are retrieved from the online encryption machine 120 and returned to the financial management server 10. Or lese, the first digital assets are retrieved from the online encryption machine 120 and the second digital assets are retrieved from the first remote encryption machine 72 and/or the second remote encryption machine 73 and then returned to the financial management server 10. Wherein, the sum of the first digital assets and the second digital assets is greater than or equal to the digital asset retrieval request.

In the system for remote management of digital assets, when the sum of the first digital assets and the second digital assets is greater than the digital asset retrieval request, the financial management server 10 returns remaining digital assets to the online encryption machine 120 for storage.

By implementing the system for remote management of digital assets, the digital assets are stored in the remote encryption machine and the online encryption machine according to different proportions, which is convenient for quick access while having enhanced security. For the digital assets stored in the online encryption machine, customers can quickly access. For the digital assets stored in the remote encryption machine, the private key is stored in the different remote encryption machines and the signatures are also carried out in the different remote encryption machines, such that even if some encryption machines are hacked, the private key will not be disclosed. The security of the digital assets is further guaranteed. In additional, the local encryption machine and the remote encryption machine can only communicate through dedicated lines, the encryption process is complex and the safety degree is high. Furthermore, the storage ratio and access rules of digital assets in the online and remote encryption machines can be configured flexibly and conveniently.

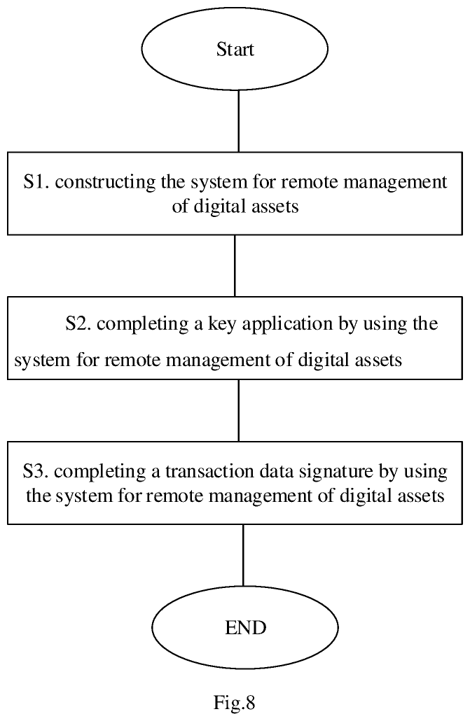

FIG. 8 is a flowchart of a method for remote management of digital assets according to a first preferred embodiment of the present disclosure. In step S1, the system for remote management of digital assets discussed above is constructed. In this embodiment, the system for remote management of digital assets can be constructed according to any embodiment shown in FIG. 1-7.

In step S2, a key application is completed by using the system for remote management of digital assets. In a preferred embodiment of the present disclosure, the key application can be completed with reference to any steps and methods mentioned in FIGS. 1-7. For example, the financial management server receives a key application and transmits it to the key server through the management server. The key server generates a key and transmits the key to the first local encryption machine which encrypts the key to generate an encrypted private key and a public key and returns the public key to the key server, generates at least three private keys based on the encrypted private key and stores a first private key internally and transmits a second private key and a third private key to the first remote encryption machine and the second remote encryption machine, respectively; wherein the key server returns the public key to the financial management server along an original path.

In step S3, a transaction data signature is completed by using the system for remote management of digital assets. The transaction data signature can be completed by referring to any methods and steps in FIGS. 1-7. For example, the financial management server receives the transaction data to be signed from an external network and transmits it to the key server through the management server. The key server encrypts the encrypted data with the public key and transmits the encrypted data to the first local encryption machine. The first local encryption machine signs the encrypted data with the first private key and then transmits a primary signature data to the first remote encryption machine and/or the second remote encryption machine. The first remote encryption machine and/or the second remote encryption machine sign the primary signature data with the second private key and/or the third private key again and then returns a secondary signature data to the key server which returns the secondary signature data to the financial management server along the original path.

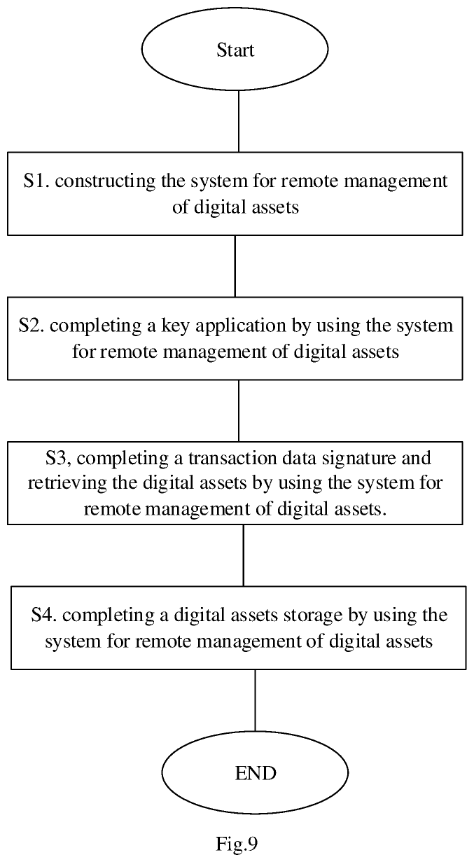

FIG. 9 is a flowchart of a method for remote management of digital assets according to a second preferred embodiment of the present disclosure. In step S1, the system for remote management of digital assets discussed above is constructed. In this embodiment, the system for remote management of digital assets can be constructed according to any embodiment shown in FIG. 1-7.

In step S2, a key application is completed by using the system for remote management of digital assets. In a preferred embodiment of the present disclosure, the key application can be completed with reference to any steps and methods mentioned in FIGS. 1-7. For example, the financial management server receives a key application and transmits it to the key server through the management server. The key server generates a key and transmits the key to the second local encryption machine which forwards the key to the first local encryption machine. The first local encryption machine encrypts the key to generate an encrypted private key and a public key and returns the public key to the key server, generates at least three private keys based on the encrypted private key and stores a first private key internally and transmits a second private key and a third private key to the first remote encryption machine and the second remote encryption machine, respectively; wherein the key server returns the public key to the financial management server along the original path.

In step S3, the digital assets are stored by using the system for remote management of digital assets. For example, in a preferred embodiment of the present disclosure, the storage of digital assets can be completed with reference to any steps or methods of the above embodiments. For example, in this step, the wallet server receives a digital asset storage request and stores a first proportion of digital assets into the online encryption machine and a second proportion of digital assets into at least one of the remote encryption machines according to a scheduled rule. In the preferred embodiment of the present disclosure, a plurality of the remote encryption machines can be arranged, and the wallet server stores digital assets in one or more remote encryption machines according to the scheduled rule. One skilled in the art know that the sequence of steps S2 and S3 can be changed as long as they are guaranteed to be implemented between steps S1 and S4.

In step S4, a transaction data signature is implemented for retrieving digital assets by using the system for remote management of digital assets. The digital assets retrieving can be completed with reference to any steps or methods of the above embodiments shown in FIGS. 3-7. The wallet server parses out a first transaction data to be signed by the online encryption machine and/or a second transaction data to be signed by the first remote encryption machine or the second remote encryption machine based on the digital asset retrieval request and the scheduled rule. The key server encrypts the first transaction data with the first public key and transmits a first encrypted data to the online encryption machine through the wallet server, the online encryption machine signs the first encrypted data with the first encrypted private key, and then returns generated first signature data to the wallet server which returns the first signature data to the financial management server along the original path. The key server encrypts the second transaction data with the second public key and transmits a second encrypted data to the first local encryption machine through the third communication channel. The first local encryption machine signs the encrypted data with the first private key and then transmits a primary signature data to the first remote encryption machine and/or the second remote encryption machine; the first remote encryption machine and/or the second remote encryption machine sign the primary signature data with the second private key and/or the third private key again and then returns a secondary signature data to the key server which returns the secondary signature data to the financial management server along the original path.

By implementing the method for remote management of digital assets, the private keys are stored in the different encryption machines and the signatures are also carried out in the different encryption machine, such that even if some encryption machines are hacked, the private key will not be disclosed. In additional, the system for remote management of digital assets is isolated through the multi-layer network isolation, the defects of being vulnerable to network attacks, having greater security risks and information leakage risks, can be avoided. Furthermore, the digital assets are stored in the remote encryption machine and the online encryption machine according to different proportions, which is convenient for quick access while having enhanced security. For the digital assets stored in the online encryption machine, customers can quickly access. For the digital assets stored in the remote encryption machine, the private key is stored in the different remote encryption machines and the signatures are also carried out in the different remote encryption machines, such that even if some encryption machines are hacked, the private key will not be disclosed. The security of the digital assets is further guaranteed. Furthermore, the storage ratio and access rules of digital assets in the online and remote encryption machines can be configured flexibly and conveniently.

Therefore, the application can be realized by hardware, software or combination of software and hardware. The present disclosure may be implemented in a centralized manner in at least one computer system or in a decentralized manner by different parts distributed in several interconnected computer systems. Any computer system or other equipment that can realize the method of the application is applicable. The combination of commonly used software and hardware can be a general-purpose computer system installed with computer programs, and the computer system can be controlled by installing and executing programs to make it run according to the method of the application.

The application can also be implemented through a computer program product, the program contains all the features that can realize the method of the application, and the method of the application can be realized when it is installed in a computer system. The computer program in this document refers to any expression of a set of instructions that can be written in any programming language, code or symbol. The instruction group enables the system to process information to directly realize a specific function, or after one or two of the following steps: a) convert to other languages, codes or symbols; b) reproduce in different formats.

Although the present disclosure is illustrated by specific embodiments, those skilled in the art should understand that various transformations and equivalent substitutions can be made to the disclosure without departing from the scope of the present disclosure. In addition, various modifications can be made to the present disclosure for specific situations or materials without departing from the scope of the disclosure. Therefore, the disclosure is not limited to the specific embodiments disclosed, but should include all the embodiments falling within the scope of the claims of the disclosure.

The above disclosure is just preferable embodiments and does not limit the present disclosure. Any modification, equivalent replacement and improvement made within the spirit and principle of the present disclosure shall be included in the protection scope of the present disclosure.

1. A system for remote management of digital assets comprising a financial management server communicating with an external network, a management server communicating with the financial management server through a first communication channel, a key server communicating with the management server through a second communication channel, a first local encryption machine communicating with the key server through a third communication channel, at least a first remote encryption machine and a second remote encryption machine communicating with the first local encryption machine through a fourth communication channel;
wherein the financial management server receives a key application and transmits the key application to the key server through the management server, the key server generates a key and transmits the key to the first local encryption machine; wherein the first local encryption machine encrypts the key to generate an encrypted private key and a public key and returns the public key to the key server, generates at least three private keys based on the encrypted private key and stores a first private key internally and transmits a second private key and a third private key to the first remote encryption machine and the second remote encryption machine, respectively; wherein the key server returns the public key to the financial management server along an original path.

2. The system for remote management of digital assets according to claim 1, wherein the financial management server receives a transaction data to be signed and transmits it to the key server through the management server; the key server encrypts the transaction data to be signed with the public key and transmits encrypted data to the first local encryption machine; wherein the first local encryption machine signs the encrypted data with the first private key and then transmits a primary signature data to the first remote encryption machine and/or the second remote encryption machine; the first remote encryption machine and/or the second remote encryption machine sign the primary signature data with the second private key and/or the third private key again and then returns a secondary signature data to the key server which returns the secondary signature data to the financial management server along the original path.

3. The system for remote management of digital assets according to claim 2, wherein the third communication channel includes a first acoustic transceiver arranged on the key server and a second acoustic transceiver arranged on the first local encryption machine; wherein the first acoustic transceiver is connected with the key server through a USB interface, and the second acoustic transceiver is connected with the first local encryption machine through a USB interface.

4. The system for remote management of digital assets according to claim 2, wherein the third communication channel includes a first QR code scanning communication device arranged on the key server and a second QR code scanning communication device arranged on the first local encryption machine, wherein the first QR code scanning communication device is communicated with the key server through a USB interface, and the second QR code scanning communication device is communicated with the first local encryption machine through a USB interface; wherein each QR code scanning communication device comprises a scanning unit and a display unit respectively.

5. (canceled)

6. The system for remote management of digital assets according to claim 4, wherein the financial management server receives the transaction data to be signed and transmits it to the key server through the management server; the key server encodes the transaction data to be signed to obtain a QR code and then encrypts obtained QR code with the public key and displays encrypted QR code on its corresponding display unit, the first local encryption machine obtains the encrypted QR code through its corresponding scanning unit, decrypts the encrypted QR code with the first private key to obtain the transaction data and signs the transaction data with the first private key to obtain a primary signature data and transmits the primary signature data to the first remote encryption machine and/or the second remote encryption machine according to the management server instruction; wherein the first remote encryption machine and/or the second remote encryption machine sign the primary signature data with the second private key and/or the third private key again and then returns a secondary signature data to the first local encryption machine; wherein the first local encryption machine encodes the secondary signature data to obtain a second signature QR code and displays the second signature QR code on its corresponding display unit; wherein the key server scans the second signature QR code to obtain the secondary signature data through its corresponding scanning unit, and returns the secondary signature data to the financial management server along the original path.

7-17. (canceled)

18. The system for remote management of digital assets according to claim 1, wherein the system for remote management of digital assets further comprises a wallet server and an online encryption machine; wherein the wallet server is communicating with the financial management server through the first communication channel and with the key server through the second communication channel, wherein the wallet server is further communicating with the online encryption machine at the same time;
wherein the wallet server receives a digital asset storage request and stores a first proportion of digital assets into the online encryption machine and a second proportion of digital assets into the first remote encryption machine and/or the second remote encryption machine according to a scheduled rule;
the financial management server receives a digital asset retrieval request and transmits it to the wallet server which retrieves the digital assets from the online encryption machine, the first remote encryption machine and/or the second remote encryption machine according to the scheduled rule and returns the digital assets to the financial management server.

19. The system for remote management of digital assets according to claim 18, wherein the financial management server receives a key application and transmits the key application to the key server through the management server, the key server generates a key and transmits the key to the first local encryption machine and the online encryption machine; wherein the online encryption machine encrypts the key to generate a first encrypted private key and a first public key, stores the first encrypted private key internally and returns the first public key to the key server and the financial management server; the first local encryption machine encrypts the key to generate a second encrypted private key and a second public key and returns the second public key to the key server, generates at least three private keys based on the encrypted private key and stores a first private key internally and transmits a second private key and a third private key to the first remote encryption machine and the second remote encryption machine, respectively; wherein the key server returns the second public key to the financial management server along an original path.

20. The system for remote management of digital assets according to claim 19, wherein the wallet server parses out a first transaction data to be signed by the online encryption machine and/or a second transaction data to be signed by the first remote encryption machine and/or the second remote encryption machine based on the digital asset retrieval request and the scheduled rule; the key server encrypts the first transaction data with the first public key and transmits a first encrypted data to the online encryption machine through the wallet server, the online encryption machine signs the first encrypted data with the first encrypted private key, and then returns generated first signature data to the financial management server along the original path; wherein the key server encrypts the second transaction data with the second public key and transmits a second encrypted data to the first local encryption machine through the third communication channel, the first local encryption machine signs the second encrypted data with the first private key and then transmits a primary signature data to the first remote encryption machine and/or the second remote encryption machine; the first remote encryption machine and/or the second remote encryption machine sign the primary signature data with the second private key and/or the third private key again and then returns a secondary signature data to the key server which returns the secondary signature data to the financial management server along the original path.

21-23. (canceled)

24. The system for remote management of digital assets according to claim 18, wherein the wallet server firstly determines whether total digital assets stored in the online encryption machine meets the digital asset retrieval request; if yes, the digital assets are retrieved from the online encryption machine and returned to the financial management server, or lese, first digital assets are retrieved from the online encryption machine and second digital assets are retrieved from the first remote encryption machine and/or the second remote encryption machine and then returned to the financial management server; wherein a sum of the first digital assets and the second digital assets is greater than or equal to the digital asset retrieval request.

25. The system for remote management of digital assets according to claim 24, wherein when the sum of the first digital assets and the second digital assets is greater than the digital asset retrieval request, the financial management server returns remaining digital assets to the online encryption machine for storage.

26-28. (canceled)

29. A system for remote management of digital assets comprising a financial management server communicating with an external network, a management server communicating with the financial management server through a first communication channel, a key server communicating with the management server through a second communication channel, a second local encryption machine communicating with the key server through a third communication channel, a first local encryption machine communicating with second local encryption machine through a fifth communication channel; at least a first remote encryption machine and a second remote encryption machine communicating with the first local encryption machine through a fourth communication channel;
wherein the financial management server receives a key application and transmits the key application to the key server through the management server, the key server generates a key and transmits the key to the second local encryption machine which forwards the key to the first local encryption machine; wherein the first local encryption machine encrypts the key to generate an encrypted private key and a public key and returns the public key to the key server, generates at least three private keys based on the encrypted private key and stores a first private key internally and transmits a second private key and a third private key to the first remote encryption machine and the second remote encryption machine, respectively; wherein the key server returns the public key to the financial management server along the original path.

30. The system for remote management of digital assets according to claim 29, wherein the financial management server receives a transaction data to be signed and transmits it to the key server through the management server; the key server forwards the transaction data to be signed to the second local encryption machine; the second local encryption machine which encrypts the transaction data to be signed with the public key and transmits encrypted data to the first local encryption machine, wherein the first local encryption machine signs the encrypted data with the first private key to obtain a primary signature and then transmits the primary signature data to the first remote encryption machine and/or the second remote encryption machine; the first remote encryption machine and/or the second remote encryption machine sign the primary signature data with the second private key and/or the third private key again and then returns a secondary signature data to the key server which returns the secondary signature data to the financial management server along the original path.

31. The system for remote management of digital assets according to claim 30, wherein the third communication channel includes a first acoustic transceiver arranged on the key server and a second acoustic transceiver arranged on the second local encryption machine; wherein the first acoustic transceiver is connected with the key server through a USB interface, and the second acoustic transceiver is connected with the second local encryption machine through a USB interface.

32. The system for remote management of digital assets according to claim 31, wherein the fifth communication channel includes a first QR code scanning communication device arranged on the second local encryption machine and a second QR code scanning communication device arranged on the first local encryption machine, wherein the first QR code scanning communication device is communicated with the second local encryption machine through a USB interface, and the second QR code scanning communication device is communicated with the first local encryption machine through a USB interface; wherein each QR code scanning communication device comprises a scanning unit and a display unit respectively.

33. The system for remote management of digital assets according to claim 32, wherein the first local encryption machine and the second local encryption machine are arranged in a closed space, while the key server is arranged outside the closed space, the first local encryption machine is connected with the first remote encryption machine and the second remote encryption machine with dedicated lines respectively.

34. The system for remote management of digital assets according to claim 33, wherein the financial management server receives the transaction data to be signed and transmits it to the key server through the management server; the key server forwards the transaction data to be signed to the second local encryption machine through the first acoustic transceiver, the second local encryption machine receives the transaction data to be signed through the second acoustic transceiver, encodes the transaction data to be signed to obtain a QR code and then encrypts obtained QR code with the public key and displays encrypted QR code on its corresponding display unit, the first local encryption machine obtains the encrypted QR code through its corresponding scanning unit, decrypts the encrypted QR code with the first private key to obtain the transaction data and signs the transaction data with the first private key to obtain a primary signature data and transmits the primary signature data to the first remote encryption machine and/or the second remote encryption machine according to the management server instruction; wherein the first remote encryption machine and/or the second remote encryption machine sign the primary signature data with the second private key and/or the third private key again and then returns a secondary signature data to the first local encryption machine; wherein the first local encryption machine encodes the secondary signature data to obtain a second signature QR code and displays the second signature QR code on its corresponding display unit; wherein the second local encryption machine scans the second signature QR code to obtain the secondary signature data through its corresponding scanning unit, and returns the secondary signature data to the financial management server along the original path.

35. The system for remote management of digital assets according to claim 29, wherein the system for remote management of digital assets further comprises a wallet server and an online encryption machine; wherein the wallet server is communicating with the financial management server through the first communication channel and with the key server through the second communication channel, wherein the wallet server is further communicating with the online encryption machine at the same time;
wherein the wallet server receives a digital asset storage request and stores a first proportion of digital assets into the online encryption machine and a second proportion of digital assets into the first remote encryption machine and/or the second remote encryption machine according to a scheduled rule;
the financial management server receives a digital asset retrieval request and transmits it to the wallet server which retrieves the digital assets from the online encryption machine, the first remote encryption machine and/or the second remote encryption machine according to the scheduled rule and returns the digital assets to the financial management server.

36. The system for remote management of digital assets according to claim 35, wherein the financial management server receives a key application and transmits the key application to the key server through the management server, the key server generates a key and transmits the key to the second local encryption machine and the online encryption machine; wherein the online encryption machine encrypts the key to generate a first encrypted private key and a first public key, stores the first encrypted private key internally and returns the first public key to the key server and the financial management server; the second local encryption machine forwards the key to the first local encryption machine which encrypts the key to generate a second encrypted private key and a second public key and returns the second public key to the key server through the second local encryption machine, generates at least three private keys based on the encrypted private key and stores a first private key internally and transmits a second private key and a third private key to the first remote encryption machine and the second remote encryption machine, respectively; wherein the key server returns the second public key to the financial management server along an original path.

37. The system for remote management of digital assets according to claim 36, wherein the wallet server parses out a first transaction data to be signed by the online encryption machine and/or a second transaction data to be signed by the first remote encryption machine and/or the second remote encryption machine based on the digital asset retrieval request and the scheduled rule; the key server encrypts the first transaction data with the first public key and transmits a first encrypted data to the online encryption machine through the wallet server, the online encryption machine signs the first encrypted data with the first encrypted private key, and then returns generated first signature data to the financial management server along the original path; wherein the key server forward the second transaction data to the second local encryption machine which encrypts the second transaction data with the second public key and transmits a second encrypted data to the first local encryption machine through the fourth communication channel, the first local encryption machine signs the second encrypted data with the first private key to obtain a primary signature data and then transmits the primary signature data to the first remote encryption machine and/or the second remote encryption machine; the first remote encryption machine and/or the second remote encryption machine sign the primary signature data with the second private key and/or the third private key again and then returns a secondary signature data to the key server which returns the secondary signature data to the financial management server along the original path.

38. The system for remote management of digital assets according to claim 29, the wallet server firstly determines whether total digital assets stored in the online encryption machine meets the digital asset retrieval request; if yes, the digital assets are retrieved from the online encryption machine and returned to the financial management server, or lese, first digital assets are retrieved from the online encryption machine and second digital assets are retrieved from the first remote encryption machine and/or the second remote encryption machine and then returned to the financial management server; wherein a sum of the first digital assets and the second digital assets is greater than or equal to the digital asset retrieval request.
